(19) United States
(12) Patent Application Publication
(10) Pub. No.: US 2007/0247984 A1
(43) Pub. Date: Oct. 25, 2007

(54) Optical Record Carrier and Optical Scanning Device

(76) Inventor: Willem Gerard Ophey, Eindhoven (NL)

Correspondence Address: PHILIPS ELECTRONICS NORTH AMERICA CORPORATION, P.O. BOX 3001, BRIARCLIFF MANOR, NY, 10510, US

(21) Appl. No.: 10/550,333

(22) PCT Filed: Mar. 23, 2004
(86) PCT No.: PCT/IB04/50315

§ 371 Date: Sep. 7, 2006

(30) Foreign Application Priority Data
Mar. 28, 2003 (EP) 03100817.0

(51) Int. Cl. G11B 7/00; G11B 7/24

(52) U.S. Cl. 369/44.26; 720/718

(57) ABSTRACT

To increase the information density of a satisfactorily readable information structure of a record carrier (2), the rearside (4) of the record carrier can be provided with means (82,84;86) for reflecting read beam radiation at an acute angle with respect to the chief ray of the incident read beam (20). In this way sub-beams b(0), b(+1), b(−1) diffracted by the information structure in different orders can be shifted with respect to the pupil of an objective lens (18) without introducing aberrations into the read spot (21). Said means may have a sawtooth or triangular shape (82,84) or be formed by a regular diffraction grating (86).

The invention relates to an optical record carrier having at least one information layer, wherein information is encoded in an information structure comprising track-wise arranged information areas, which alternate in the track direction with intermediate areas.

Such a record carrier is well known in the art and its information structure can be read by means of a dedicated read device. This device comprises a radiation source, usually a diode laser, which generates a read beam having a given wavelength. An objective lens comprising one or more lens element(s) focuses the read beam to a read spot on the information layer. The read spot scans an information track, for example by rotating the disc-shaped record carrier relative to the read spot. Moving the record carrier and the read spot relative to each other in the radial direction allows scanning and thus reading of all information tracks. The size of the read spot is larger than that of the individual information areas, so that these areas diffract the incident read beam, i.e. split this beam into a non-deflected zero-order sub-beam and a number of deflected higher-order sub-beams. Current optical record carriers have a reflective information layer, and the zero-order sub-beam and portion of the first-order sub-beams reflected by the information layer pass through the objective lens. This lens concentrates the radiation portions on a radiation-sensitive detection system, whereby these radiation portions interfere with each other. The radiation-sensitive detection system, which comprises one or more detectors, converts the radiation incident on it in an electrical signal, which represents the information momentarily being read out.

There is a steady demand for ever increasing information density on optical record carriers, i.e. ever decreasing size of the information areas and intermediate areas and decreasing distance between the information tracks. A read spot with a correspondingly decreased size should be used for reading information areas with decreased size, otherwise the information areas cannot be read separately. This means that the resolution of the reading device should be increased. The conventional resolution of a read device is proportional to NA/λ, wherein NA is the numerical aperture of the objective lens and λ is the wavelength of read beam. Increasing NA and/or decreasing λ could increase the resolution. The fact that the depth focus of the objective lens is proportional to λ/(NA)² sets a limit to the increase of the NA, because the depth of focus will become too small for a large NA. Reading devices with sufficiently small read wavelengths can be realized only when diode lasers emitting such small wavelengths are available.

U.S. Pat. No. 4,242,579 describes a reading device having a resolution which is, for example, twice the conventional resolution. The increased resolution is realized in that the objective lens passes only portions of only one first-order sub-beam and of the zero-order sub-beam of the reflected read radiation to the radiation-sensitive detection system, and in that a detector having a small dimension in the scan direction is used. To that end, the read beam and the record carrier are tilted relative to each other, i.e. the read beam is not incident perpendicularly on the record carrier. As the read beam has to pass the substrate of the record carrier and this substrate has a given thickness, for example 1.2 mm, so as to give the record carrier sufficient mechanical strength, an unacceptable amount of aberration, such as coma and astigmatism, is introduced into the read beam. This results in a read spot on the information which is larger than is acceptable and which causes crosstalk.

It is an object of the invention to realize super resolution, i.e. reading an optical record carrier having an information structure pitch which is smaller than the resolution of the objective lens, without using a skew read beam or tilted record carrier. According to the invention, this object is realized by means of a record carrier as defined in the opening paragraph, which is characterized in that that the information layer comprises means for directing radiation of a read beam, which is perpendicularly incident on the information layer, in a direction at an acute angle to the chief ray of the incident beam.

Providing the record carrier with said means allows reading with super resolution whilst using a read beam which is perpendicularly incident on the record carrier and passes perpendicularly through the carrier substrate so that no coma and astigmatic aberration occurs. Perpendicularly incident is understood to mean that the chief ray of the incident read beam, which is currently a converged beam, is perpendicular to the record carrier. The said means deflect portions of the zero-order sub beam and of one first-order sub-beam such that these portions pass through the objective lens and are focused by this lens on the radiation-sensitive detector to interfere at the location of this detector. This detector may be the same as used in the read device disclosed in U.S. Pat. No. 4,242,579.

A first embodiment of the record carrier according to the invention is characterized in that said means are constituted by a surface profile of the information layer, which profile comprises first surface portions having a first inclination with respect to the normal in the center of the record carrier, said first surface portions alternating with second surface portions having a second inclination opposed to the first inclination.

The first surface portions deflect one of the +1 order and −1 order sub-beams and the zero-order sub-beam, which are generated by the information structure, in a first direction such that radiation of these sub-beams passes the objective lens eccentrically. The second surface portions deflect the other first-order sub-beam and the zero-order sub-beam in a second direction, opposed to the first direction, such that radiation of these sub-beams passes the objective lens eccentrically. In this way it is achieved that during reading, radiation of the zero-order sub-beam and one of the first-order sub-beams will always pass through the objective lens, whilst the incident read beam is perpendicular to the record carrier. As the first-order sub-beams have the same information content a read signal is permanently present during reading.

The surface profile of a disc-shaped record carrier may extend in the tangential direction, i.e. in the track direction. However, in view of the focus servo, the first embodiment is preferably characterized in that the surface profile extends in the radial direction of the disc. in this way it can be avoided that the bandwidth of the focus servo system, which should correct the focus of the read beam for unevenness or inclinations of the information layer, should be enlarged.

Instead of in the radial direction or in the tangential direction, the surface profile may extend in any direction therebetween. The preferred direction is determined by the pattern according to which the information areas are arranged in the information layer and the way in which these areas are read. The information areas may be arranged not only track-wise, i.e. in tracks having a width sufficient to accommodate one information area, but also in a two-dimensional pattern, i.e. a number of information areas are arranged in a two-dimensional block each time, so that the information areas of such a block are read simultaneously, for example by a two-dimensional detector array. The information is then encoded in a lattice structure representing bit positions of the coded information in two dimensions. Said block of information areas may have a hexagonal shape.

The first embodiment of the record carrier may be further characterized in that the surface profile is a sawtooth profile.

Alternatively, the first embodiment of the record carrier is characterized in that the surface profile is a triangular profile.

A second embodiment of the record carrier is characterized in that said means are constituted by a grating having a grating pitch larger that the pitch of the information structure.

This grating, which may be called regular or information-less grating to distinguish it from the diffractive information structure, splits an incident beam in a zero-order sub-beam, a couple of first-order sub-beams, and couples of higher-order sub-beams. As the pitch of the regular grating is larger than the pitch of the information structure, the regular grating deflects the first-order sub-beams through smaller angles than does the information structure. The effect of the regular grating is that first-order sub-beams formed by the information structure are split up into a zero-order sub-beam and deflected secondary first-order sub-beams, some of which enter the objective lens to interfere with the zero-order sub-beam at the detection system. Such secondary first-order sub-beams are, for example the (−1, +1) sub-beam and the (+1, −1) sub-beam, wherein the first number relates to the diffraction by the information structure and the second number to the diffraction by the regular grating.

The strip-shaped regions of the grating also may extend in the radial direction or in the tangential direction or in any direction there between.

If the pitch of the information areas varies across the record carrier, for example decreases from the outer tracks to the inner tracks, the pitch of the grating may show a corresponding variation. In that case the passage “the pitch of the grating is larger than the pitch of the grating structure” is understood to mean that the pitch of the grating at a surface area of the record carrier is larger than the local pitch of the information structure.

The second embodiment of the record carrier may be further characterized in that the grating comprises a structure of alternating first regions having a first refraction coefficient and second regions having a second refraction coefficient different from the first refraction coefficient.

Such a, flat, phase grating may be formed, for example, in a phase change layer of which first regions are in the crystalline state and second regions are in an amorphous state. A phase change layer is well-known layer in the technique of optical recording and is a layer of material that can be switched between a crystalline state and an amorphous state by means of a beam of radiation having sufficient power. In the record carrier according to the invention, the phase change layer covers the information layer and is in its turn covered by a reflective layer.

Alternatively, the second embodiment of the record carrier may be characterized in that the grating comprises a structure of alternating first regions having a first height and second regions having a second height different from the first height A third embodiment of the record carries is characterized in that the grating comprises first surface regions portions having a first inclination with respect to the normal in the center of the record carrier, which first surface portions alternate with second surface portions having a second inclination opposed to the first inclination This embodiment resembles the first embodiment having a triangular or sawtooth surface relief. However, the structure now has a smaller pitch such that it acts as a grating for the wavelength of the read beam.

The invention may also be applied outside the optical record technology, for example in confocal scanning microscopy. The implementation of the invention comprises providing the sample, or in general an information plane of an object, to be viewed or inspected by the microscope with a surface profile or regular grating, for example in the form of a phase plate comprising the profile or grating, which plate covers the information plane during scanning. As the plate forms part of the scanning device, the invention is now implemented in this device. The scanning device according to the invention, which device comprises a radiation source for supplying a scanning beam, an objective system for focusing the scanning beam which is perpendicularly incident on the information plane in a scanning spot, an object holder for holding the object, and a radiation-sensitive detection system for converting radiation from the information plane into an electrical signal, is characterized in that it comprises a plate arranged to cover the information plane during a scanning action, which plate is provided with means for directing scanning beam radiation from the information plane in a direction at an acute angle to the chief ray of the incident beam.

An information plane is understood to mean any plane wherein relevant information is present about an object that is to be inspected of from which information is to be retrieved. Such information may relate to surface conditions, to physical or chemical properties or structure of the object material, indeed any information which can be optically retrieved.

These and other aspects of the invention will be apparent from and elucidated by way of non-limitative example with reference to the embodiments described hereinafter and illustrated in the accompanying drawings.

In the drawings:

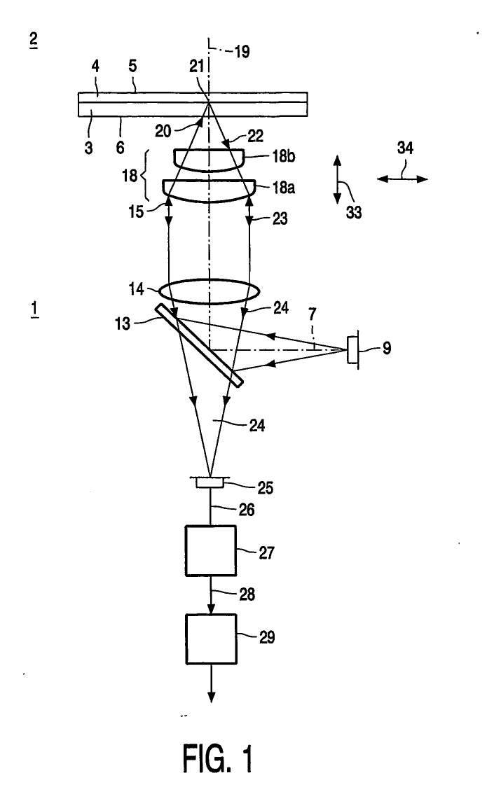

FIG. 1 shows a diagram of a read device for reading a record carrier according to the invention;

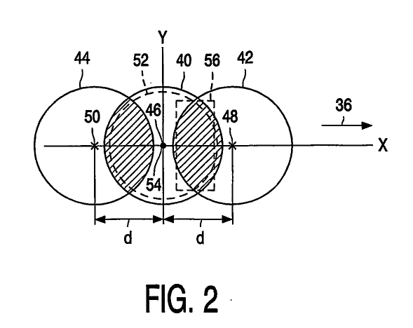

FIG. 2 shows the positions of the sub-beams of different diffraction orders relative to the pupil of the objective lens of the device;

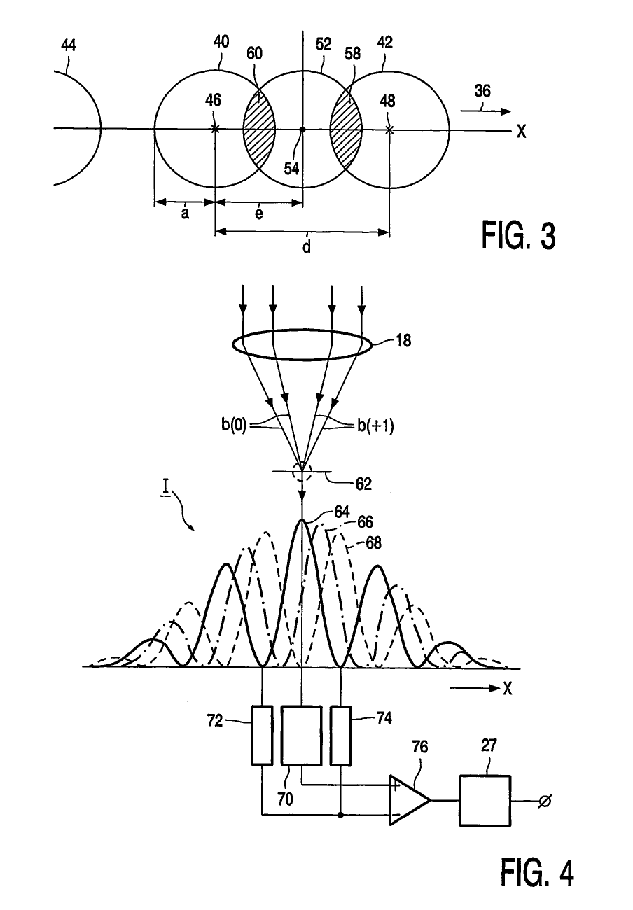

FIG. 3 shows these positions for a record carrier according to the invention.

FIG. 4 shows the principle of reading with enhanced resolution by means of shifting sub-beams diffracted by the information structure;

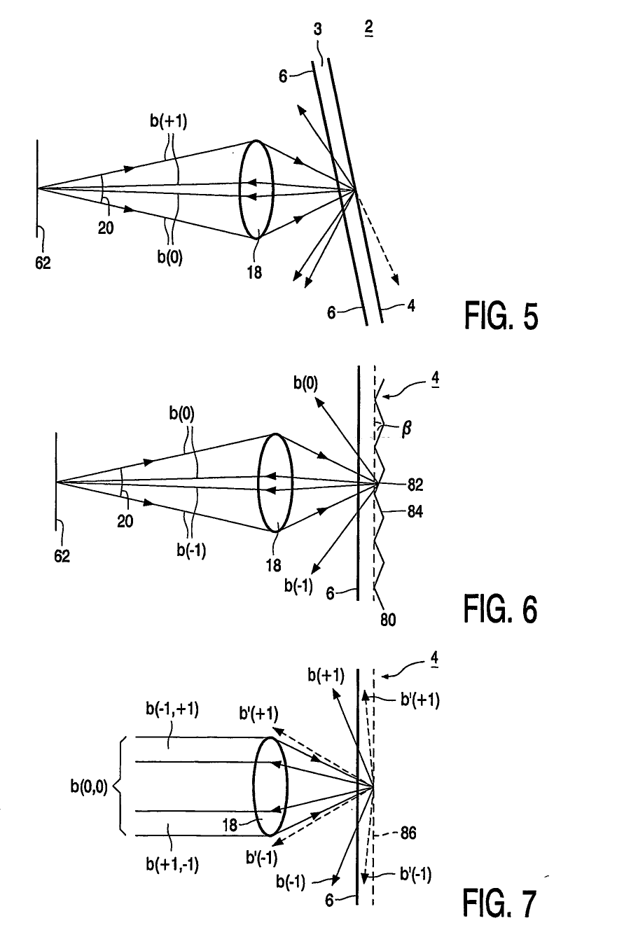

FIG. 5 shows the implementation of this principle by means of a tilted record carrier;

FIG. 6 shows a first embodiment of the record carrier according to the invention, which allows implementing the principle, and FIG. 7 shows a second embodiment of such a record carrier.

FIG. 1 diagrammatically shows an embodiment of a device for scanning an optical record carrier 2. The record carrier is in the form of an optical disc that comprises a transparent layer 3, on one side of which an information layer 4 is arranged. The side of the information layer facing away from the transparent layer is protected from environmental influences by a protection layer 5. The side of the transparent layer 3 facing the device is called the entrance face 6. The transparent layer acts as a substrate for the record carrier by providing mechanical support for the information layer and/or as a protective layer for the information layer by keeping dust particles, scratches and fingerprints away from this layer. Information may be stored in the information layer 4 of the record carrier in the form of optically detectable information areas or marks arranged in substantially parallel concentric or spiraling tracks not shown in FIG. 1. These information areas alternate with intermediate areas in the track direction. The information areas may be in any optically readable form, e.g. in the form of pits or bumps or areas with a reflection coefficient or a direction of magnetization different from their surroundings, or a combination of these forms.

The scanning device I comprises a radiation source, preferably in the form of a semiconductor laser 9 emitting a radiation beam 7. The radiation beam, or read beam, is used for scanning the information layer 4 of the optical record carrier 2. A beam splitter 13, for example a semi-transparent mirror, reflects the diverging radiation beam from the radiation source 9 along the optical path towards a collimator lens 14, which converts the diverging beam 7 into a collimated beam 15. The collimated beam is incident on an objective system 18. The objective system, usually called objective lens, may comprise one or more lenses and/or a grating. The objective system of FIG. 1 consists of two elements in this example a first lens 18a and a second lens 18b. The objective lens 18 has an optical axis 19. The objective lens changes the beam 15 into a converging beam 20 which is incident on the entrance face 6 of the record carrier 2. The converging beam 20 forms a read spot 21 on the information layer 4.

Radiation reflected by the information layer 4 forms a diverging beam 22, which is transformed into a substantially collimated beam 23 by the objective lens 18 and subsequently into a converging beam 24 by the collimator lens 14. The beam splitter 13 separates the forward beam 12 and the reflected beam 24 by transmitting at least part of the converging beam 24 towards a radiation-sensitive detection system 25. The detection system captures the radiation transmitted by the beam splitter 13 and converts it into electrical output signals 26. A signal processor 27 converts these output signals into various other signals, which are processed by a signal processing circuit 29. The processing circuits 27 and 29 may be located in the scanning device separately from the optical head 1.

One of the signals is an information signal 28, the value of which represents information read from the information layer 4. The information signal is processed by an information-processing unit for error correction 29. Other signals from the signal processor 27 are a focus error signal and a radial error signal. The focus error signal represents the axial height difference between the spot 21 and the information layer 4. The radial error signal represents the distance in the plane of the information layer 4 between the spot 21 and the center of a track in the information layer to be followed by the spot.

The focus error signal and the radial error signal are fed to a servo circuit, which converts these signals into a focus servo signal for controlling a mechanical focus actuator (not shown) in the optical head and a tracking servo signal for controlling the centering of the spot on the track being momentarily scanned. The mechanical focus actuator controls the position of the objective lens 18 in the focus direction 33, thereby controlling the actual position of the spot 21 such that it coincides substantially with the plane of the information layer 4. A further mechanical actuator, such as a radially movable arm (not shown) alters the position of the optical head I in the radial direction 34 of the record carrier 2, thereby controlling the radial position of the spot 21 to lie above a track to be followed in the information layer 4. The tracks in the record carrier 2 run in a direction perpendicular to the plane of FIG. 1 As is described in U.S. Pat. No. 4,242,579, the portion of the information structure in the vicinity of the scanning spot 21 behaves as a two-dimensional diffraction grating, which splits the incident read beam 20 into a, non-deflected, zero order sub-beam and deflected first-order sub-beams and higher-order sub-beams. The zero-order sub-beam and portions of the deflected sub-beams again enter the objective lens 18. The centers of the various sub-beams are spaced apart from each other in the plane of the exit pupil of the objective lens. FIG. 2 shows the situation in this plane.

The circle 40 having the center 46 represents the cross-section of the zero-order sub-beam in this plane. The circles 42 and 44 having centers 48 and 50 represent the cross-sections of the (+1) order sub-beam and the (−1) order sub-beam, respectively, which are diffracted in the tangential, or track direction 36. In FIG. 2 the dashed circle 52 represents the pupil of the objective lens. For the situation shown in this Figure, the zero-order sub-beam fills the pupil entirely, so that in reality the circles 40 and 52 coincide. Only that portion of the radiation coming from the information layer that falls within the objective pupil is used for information scanning. Information reading uses the phase variations in the (+1) and (−1) order sub-beams relative to the zero-order sub-beam.

In the hatched areas in FIG. 2 said first-order sub-beams overlap the zero-order sub-beam, so that interference occurs. The phases of the first-order sub-beams vary if the scanning spot moves across an information track. As a result, the intensity of the total radiation passing through the exit pupil of the objective lens, and thus incident on the radiation-sensitive detection system, varies.

When the center of the scanning or read spot coincides with the center of an information area, for example a pit, a given phase difference N exists between a first-order sub-beam and the zero-order sub-beam. If the scanning spot moves from a first information area to the next information area, the phase of the first order beam increases by 2π. Therefore, it may be stated that as the scanning spot moves in the tangential direction the phase of the first-order sub-beam relative to the zero-order sub-beam varies by ω.t. Therein ω represents a time frequency, which is determined by the spatial frequency of the information areas and by the scanning speed. The phase φ(+1) of the first-order sub-beam b(+1) relative to the zero-order sub-beam may then be represented by:
φ(+1)=104 =ω.t

The intensity variation caused by interference of the b(+1) sub-beams with the zero-order sub-beam can be detected by a radiation-sensitive detection element 56, represented by broken lines in FIG. 2, which detector is disposed in the plane of the exit pupil of the objective lens or in an image thereof. For a specific phase depth of the information structure, for which ψ=π radians, the intensity variation across the exit pupil is symmetrical. Then, as shown in FIG. 1, the beam portions passing through the two areas of overlap can be concentrated on one detector element. The time-dependent output signal of the detector 25 may then be represented by:
Si =A(ψ).cosψ.cosωt

Wherein A(ψ) decreases at decreasing values of ψ. For a given phase depth of the information structure, the amplitude A(ψ)cosψ is constant. The frequency of the signal Si is then determined by the information which is momentarily being scanned.

So far only first-order sub-beams have been discussed. It is obvious that the information structure will diffract radiation in higher diffraction orders. The radiation intensity in these orders is low and the diffraction angles are so large at the high spatial frequencies of the information structure considered here that a negligibly small portion of the higher-order beam will fall within the pupil of the objective lens 18. The influence of the higher-order beams on the detector signal Si may therefore be disregarded.

The optical scanning system discussed above has a given cut-off frequency f_{c}. The distance d between the center 46 of the objective pupil 52 and the centers 48 and 50 of the first-order sub-beams is proportional to λ.f, where f represents the spatial frequency of the information areas in the scan direction and λ the wavelength of the scanning beam 20. FIG. 2 represents the situation that the frequency f is slightly higher than half the cut-off frequency f_{c} . If the frequency f increases, the (+1) order sub-beam moves to the right and the (−1) order sub-beam moves to the left, and the distance d increases. For a given value of f, known as the conventional cut-off frequency f_{c}, the circles 42 and 44 no longer intersect the circle 52, but are merely tangent to this circle. The first-order sub-beams then no longer pass through the pupil of the objective lens 18 and these sub-beams can no longer interfere with the zero-order sub-beam. The information of the record carrier can them no longer be scanned by detecting the total radiation energy which passes through the objective pupil. For reading out in reflection, as shown in FIG. 1, the conventional cut-off frequency is given by:
F_{c}=2.NA/λ
wherein NA is the numerical aperture of the objective lens.

In order to increase the resolution of the scanning device, i.e. to allow reading of spatial frequencies higher than the conventional cut-off frequency, it is proposed in U.S. Pat. No. 4,242,579 to shift the sub-beams relative to the pupil of the objective lens in the tangential direction 36. The shift is such that a portion of a first-order sub-beam and a portion of the zero-order sub-beam still pass through the pupil of the objective lens also if the spatial frequency of the information structure is higher than the cut-off frequency.

FIG. 3 represents the situation in which the spatial frequency is approximately 1.5 times higher than the cut-off frequency of the scanning device of FIGS. 1 and 2. The distance d between the center 46 of the zero-order sub-beam and the center 48 of the +first-order sub-beam 42 is approximately 3 times the distance d in FIG. 2. Because these sub-beams have been shifted to the left in FIG. 3, the hatched portions 48 and 60 fall within the pupil 52 of the objective lens. The-first-order sub-beam 44 now falls entirely outside this pupil.

As shown in FIG. 4, the portions of the zero-order sub-beam b(0) and of the first-order sub-beam b(+1) passing through the objective lens 18, represented here by a single lens element, and through the collimator lens 14 are concentrated in the plane 62 of the detector 25. Since the scanning beam is a coherent beam, said beam portions will interfere with each other in the plane 62, so that an interference pattern I is produced which varies in tangential direction 36, as is denoted by the curves 64, 66 and 68 in FIG. 4. The solid curve 64 represents the intensity variation when the scanning spot 21 is situated exactly on the center of an information area. If the scanning spot moves away from this center to a subsequent information area, the intensity patterns at two consecutive instants will be in accordance with the dash-dot curve 66 and the dashed curve 68, respectively. The intensity pattern thus travels across the detection plane during scanning of the read spot 21. For a narrow detector having a fixed location, such as detector 70 in FIG. 4, the radiation this detector receives will consequently vary during scanning. Thus the output signal of this detector varies independence on the information being read momentarily.

The width of the detector, in the tangential direction, should be small relative to the period of the intensity pattern. This period is determined by the local spatial frequency of the information areas being scanned. The maximum spatial frequency is known for a specific information structure in a record carrier or of documents or optical representations to be scanned, so that the width of the detector 70 can be adapted accordingly.

The output signal of detector 70 is supplied to a signal processor 27. The signal-to-noise ratio of the read-out signal can be improved by arranging two additional detectors 72 and 74 on both sides of detector 70 and at a distance of approximately half the period of the intensity pattern. The output signals of the detectors are added, and their sum is subtracted from the output signal of detector 30 in a differential amplifier 76 whose output is connected to the signal processor 27 shown in FIG. 1.

In the scanning device of U.S. Pat. No. 4,242,579, the shift of the sub-beams with respect to the pupil of the objective lens shown in FIG. 3 is realized by tilting of the axes of the objective lens and the record carrier relative to each other, as is schematically shown in FIG. 5. This and the following FIGS. show only those elements of FIG. 1 which are relevant to the present invention, i.e. the record carrier 2, the objective lens 18, and the image plane 62 where the radiation-sensitive detection system should be located. The tilt angle, and thus the angle of incidence of the chief ray of the read beam 20 on the record carrier, is chosen such that a portion of the reflected zero-order sub-beam b(0) and a portion of one of the reflected first-order sub-beams pass this pupil. In the tilt position shown in FIG. 5 the zero-order sub-beam and the first-order sub-beam are deflected downwards so that a portion of the first-order sub-beam b(+1) passes through one half of the pupil of the objective lens and a portion of the zero-order beam b(0) passes through the other half of this pupil.

As the focused read beam passes the substrate of the record carrier in a skew direction and as this substrate should have a given thickness for the envisaged applications, an unacceptable amount of aberration is introduced into the read beam and thus into the read spot A main aberration is coma, which may cause crosstalk between neighboring tracks of the information structure. Other aberrations are astigmatism and higher-order aberrations. According to the invention, deflection of the sub-beams is realized by adaptation of the information layer surface such that during reading the front surface of the record carrier, i.e. the surface directed to the objective lens, is perpendicular to the chief ray of the read beam. This results in a new type of record carrier.

FIG. 6 schematically shows elements of the read device and a first embodiment of such a record carrier. The rear surface, i.e. the information layer 4, of the record carrier has a triangular shape 80, i.e. comprises alternating first regions 82, which show a first inclination or tilt, and second regions 84, which show a second tilt opposed to the first tilt. The pitch of the triangular shape is such that it only deflects the read beam while being reflected and does not split this beam into sub-beams. This pitch, or spatial period is thus larger than the pitch of the information structure, i.e. the sum of the length (in the read direction) of an information area and that of an intermediate area. The angle β at which a facet 82, 84 is tilted with respect to a plane parallel to the entrance surface 6 is chosen such that the angle at which the sub-beams are reflected by a facet is smaller than the angle at which the first-order sub-beams are diffracted by the information structure. As a rule of thumb, the angle β is of the order of half the aperture angle α of the beam focused on the information layer. For example, if the record carrier is to be read by means of an objective lens having a numerical Aperture NA=0.85, the aperture angle α is 36° and the tilt angle β is 18°.

The triangular shape is superposed on the information structure. If the read beam is incident on a facet 82, the sub-beams formed by the information structure will be deflected upwards, such that a portion of the zero-order sub-beam b(0) and a portion of the first-order sub-beam b(−1) will pass through different halves of the pupil of the objective lens, thus allowing reading of the high-density information at the location of this facet. If the read beam is incident on a facet 84, the sub-beams formed by the information structure will be deflected downwards, such that a portion of the first-order sub-beam b(+1) and a portion of the zero-order sub-beam will pass through different halves of the objective lens pupil. The phase modulation introduced by the information structure in the b(+1) sub-beam is the same as the phase modulation introduced in the b(−1) sub-beam.

During reading of the information structure, either a portion of the b(+1) or of the b(−1) sub-beam passes through the objective lens pupil together with a portion of the zero-order sub-beam at any moment. This means that at each moment the radiation-sensitive detection system supplies an information signal Si (26) at each and every moment. The triangular shape of the information layer thus allows the reading of the same high-density information structure as can be read with a tilted record carrier. However, the read beam does not pass obliquely through the carrier substrate so that unacceptable large aberrations are no longer introduced into this beam and into the read spot formed by this beam. The spherical aberration that may be introduced by the triangular thickness variation of the information layer is so small that it can be disregarded.

The schematic cross-sectional view of the record carrier with a triangular surface profile may be a tangential or a radial cross-section. However, if the succession of the facets 82 and 84 is in the tangential, i.e. the scan, direction, a considerably larger bandwidth is required for the focus servo loop to keep the read beam focused on the information structure. Then, it is preferred to have said succession in the radial direction, in the case in which the information areas are arranged along circular or quasi-circular tracks. The said succession may also be in any direction between the tangential direction and the radial direction. The preferred direction is determined by the arrangement of the information areas and the way these areas are read. The preferred direction for an information structure arranged in tracks may be different from that for an information structure which is arranged otherwise. In a track-wise arranged information structure the information areas succeed each other in the track direction, and the track width suffices to accommodate only one information area. Only one information area is read at any time. An example of a differently arranged information structure is a so-called 2D-OS (two-dimensional optical storage). These structures are divided into a number of blocks which each comprise a number of information areas. These blocks may have a hexagonal shape. The information areas of one block are all read out simultaneously, for example by means of an array of detection elements, the number of which corresponds to the number of information areas in the block. A 2D-OS information structure is described in previously filed co-pending application PHNL020147. For a two-dimensional information structure, the preferred direction of the surface profile or of the grating strips may be diagonal with respect to the blocks.

Instead of a triangular profile, the information layer may also show a sawtooth-shaped rear surface.

For a record carrier wherein the pitch of the information areas is variable, for example decreases from the outer tracks to the inner tracks, the pitch of the surface profile may be made variable, such that this pitch follows that of the pitch of the information structure.

FIG. 7 schematically shows a second embodiment of the record carrier according to the invention. The information layer 4 is now a flat layer which is provided with a regular diffraction grating denoted by the broken line 86 in FIG. 7. Such a grating comprises a periodic structure of alternating grating strips and intermediate strips and splits an incident radiation beam into a zero-order sub-beam, a (+1) order sub-beam and a (−1) order sub-beam, which first-order sub-beams are denoted by the broken arrow lines b′(+1) and b′(−1), respectively. The period of the regular grating is larger than the period of the information structure, so that the sub-beams b′(+1) and b′(−1) are deflected by the regular grating at an angle that is smaller than the angle at which the sub-beams b(+1) and b(−1) are deflected by the information structure. The sub-beams b(+1) an b(−1) are denoted by a single solid arrow line in FIG. 7. As the regular grating is superposed on the information structure, each of the zero- and first-order sub-beams b(0), b(+1) and b(−1) formed by the information structure will be further diffracted by the regular grating into double-diffracted zero-order and first-order sub-beams. Of these reflected, double-diffracted sub-beams, the sub-beams, b(−1,+1) and b(+1,−1) pass through the pupil of the objective lens and collimator lens, as shown in FIG. 7. The first and the second index relate to the order of diffraction caused by the information structure and by the regular grating, respectively. The sub-beam b(0,0), not shown in FIG. 7, which has the same but opposed ray direction as the incident read beam, also passes through the pupil. In this way it is achieved that first-order sub-beams which are modulated by the information structure interfere with a zero-order sub-beam at the location of the radiation-sensitive detection system, and reading with substantially enhanced resolution becomes possible.

As the regular grating is a flat element for the focus servo system of the read apparatus, the grating strips may extend in the tangential or in the radial direction of a disc-shaped carrier having the information areas arranged in tracks, or in any other direction. Again, the preferred direction is determined by the pattern according to which the information areas are arranged and the way the information areas are read out.

The pitch of the regular grating may again be made variable, if the pitch of the information structure is variable, such that the grating pitch follows the pitch of the information structure.

Provided that it diffracts incident radiation in the required range of deflection angles, the regular grating may be any kind of amplitude or phase grating. In view of radiation efficiency the grating is preferably a phase grating. Such a grating may comprise grating strips at another height than the intermediate strips. Alternatively, the grating may comprise grating strips having an index of refraction different from that of the intermediate strips. For example, the material of the latter grating is a phase change material which has been processed such that the material of the grating strips is in a crystalline state, whilst that of the intermediate strips is in an amorphous state.

The regular grating may also be constituted by a surface shape similar to that shown in FIG. 5, i.e. a triangular shape or a sawtooth shape, but having a substantially smaller period such that it diffracts incident read radiation. It can be arranged that the same double-diffracted sub-beams as shown in FIG. 7 pass through the pupil of the objective lens.

The mastering step, which forms part of the manufacturing process of the record carrier, may be adapted so as to provide a record carrier with the required surface profile or regular grating. In the mastering step, a resist layer on top of a substrate is exposed to a focused beam of radiation whose intensity is modulated in accordance with the information to be written. The modulated scanning across the resist layer forms a pattern of exposed areas alternating with non-exposed areas in the resist layer. Developing the resist and using the resist pattern as an etch mask transfers this pattern into the substrate. From this substrate, which is called a master, different generations of molds are made, which molds are used to make record carriers. To obtain a record carrier having a surface profile or the regular grating according to the invention, the required surface profile or regular grating can be encoded in the signal which controls the modulation of the writing beam so that the profile or grating is inscribed in the master.

Alternatively, the surface profile or grating may be fixed in a separate layer on top of the information layer. For example, the separate layer may be a layer of phase change material into which the surface profile or grating can be written by a beam focused onto a spot that is larger than the write spot used for writing the information structure.

The invention provides a general concept for increasing the information density of an information layer in an optical record carrier that can still be read out satisfactorily and can be used with optical record carriers of different types, such as CD, DVD and record carriers of a higher density type.

The invention may also be used in a multi-layer record carrier, i.e. a record carrier having two or more information layers. Each of the information layers should be provided with a surface profile or regular grating as discussed above.

The invention may also be applied outside optical recording technology, for example in confocal scanning microscopy. The implementation of the invention comprises providing the sample, or in general an information plane, to be viewed or inspected by the microscope with a surface profile or regular grating, for example in the form of a phase plate comprising the profile or grating, which plate covers the information plane during scanning. The pitch of the profile or grating should be larger than the pitch(es) expected to be present in the sample. The said plate forms part of the scanning device so that the invention is now implemented in the device. The scanning device according to the invention differs from conventional confocal scanning microscopes, or scanning devices in general, in that it comprises a plate provided with means for directing the scanning beam radiation from the information plane in a direction at an acute angle to the chief ray of the incident scanning beam. As the different embodiments of the plate means are similar to those for the record carrier means described above, the plate means need not to be described in detail.

1. An optically readable record carrier having at least one information layer, wherein information is encoded in an information structure comprising track-wise arranged information areas which alternate in the track direction with intermediate areas, characterized in that the information layer comprises means for directing radiation of a read beam, which is perpendicularly incident on the information layer, in a direction at an acute angle to the chief ray of the incident beam.

2. An optical record carrier as claimed in claim 1, characterized in that said means are constituted by a surface profile of the information layer, which profile comprises first surface portions having a first inclination with respect to the normal in the center of the record carrier, said first surface portions alternating with second surface portions having a second inclination opposed to the first inclination.

3. An optical record carrier as claimed in claim 2 having a disc shape, characterized in that the surface profile extends in the radial direction of the disc.

4. An optical record carrier as claimed in claim 3, characterized in that the surface profile is a sawtooth profile.

5. An optical record carrier as claimed in claim 3, characterized in that the surface profile is a triangular profile.

6. An optical record carrier as claimed in claim 1, characterized in that said means are constituted by a grating having a grating pitch larger that the pitch of the information structure.

7. An optical record carrier as claimed in claim 6, characterized in that the grating comprises a structure of alternating first regions having a first refraction coefficient and second regions having a second refraction coefficient different from the first refraction coefficient.

8. An optical record carrier as claimed in claim 6, characterized in that the grating comprises a structure of alternating first regions having a first height and second regions having a second height different from the first height.

9. An optical record carrier as claimed in claim 6, characterized in that the grating comprises first surface portions having a first inclination with respect to the normal in the center of the record carrier, which first surface portions alternate with second surface portions having a second inclination opposed to the first inclination.

10. A scanning device for scanning an information plane, which device comprises a radiation source for supplying a scanning beam, an objective system for focusing the scanning beam which is perpendicularly incident on the information plane in a scanning spot, an object holder for holding the object, and a radiation-sensitive detection system for converting radiation from the information plane into an electrical signal, characterized in that it comprises a plate arranged to cover the information plane during a scanning action, which plate is provided with means for directing scanning beam radiation from the information plane in a direction at an acute angle to the chief ray of the incident scanning beam.

11. A scanning device as claimed in claim 10, characterized in that said means are constituted by a surface profile of the plate, which profile comprises first surface portions having a first inclination with respect to the normal to the plate, said first surface portions alternating with second surface portions having a second inclination opposed to the first inclination.

12. A scanning device as claimed in claim 11, characterized in that the surface profile is a sawtooth profile.

13. A scanning device as claimed in claim 11, characterized in that the surface profile is a triangular profile.

14. A scanning device as claimed in claim 10, characterized in that said means are constituted by a diffraction grating.
